(19) United States
(12) Patent Application Publication
(10) Pub. No.: US 2026/0360194 A1
(43) Pub. Date: Nov. 12, 2026

(54) SYSTEM AND METHOD FOR MONITORING A VEHICLE

(71) Applicant: Transportation IP Holdings, LLC, Norwalk, CT (US)

(72) Inventors: Susan Peterson Sturm, Norwalk, CT (US); Lawrence Deloss Lowe, III, Norwalk, CT (US); Gnouma Diagana, Norwalk, CT (US); Matthew Fischer, Norwalk, CT (US); Curtis Mechling, Norwalk, CT (US)

(73) Assignee: Transportation IP Holdings, LLC, Norwalk, CT (US)

(21) Appl. No.: 19/203,851

(22) Filed: May 9, 2025

(51) Int. Cl. G07C 5/08; G07C 5/02

(52) U.S. Cl. CPC G07C 5/0808; G07C 5/02; G07C 5/0816

(57) ABSTRACT

A system and a method for real-time monitoring, anomaly detection, of vehicle control system data. The system includes component agents deployed on control devices and a central hub agent that aggregates data, identifies anomalies, verifies the anomalies, securely transmits alerts to third-party systems, and causes the system to perform actions.

### BACKGROUND

### Technical Field

The present disclosure relates to a system and method to monitor vehicle control systems and other related devices.

### Discussion of Art

Some vehicle operators may have traditionally relied on third-party security solutions that use passive network traffic monitoring to identify assets on transportation networks. These solutions, however, fail to capture complete asset inventory data or provide actionable alerts for critical events. The existing solutions may overwhelm personnel with excessive alerts, resulting in alert fatigue.

Rail security systems may lack visibility when they rely on passive network traffic inspection, which may provide limited asset inventory information and may lack critical security details like software versions. These systems may not gather comprehensive onboard locomotive control system data beyond the train control systems or electronic train management systems. Some detection methods may be less effective because passive monitoring-based anomaly detection fails to identify critical events effectively, resulting in excessive alerts that overwhelm Security Operation Center (SOC) personnel. Additionally, some solutions may be siloed and difficult to integrate with existing third-party systems like Security Information and Event Management (SIEM) or Configuration Management solutions leading to disparate technologies without overlapping capabilities on different systems of record. There may be an economic advantage gained if there are minimal changes necessary to existing assets. It may be desirable to have a system and method that differs from those that are currently available.

### SUMMARY

In various embodiments, a system is provided for one or more computers to perform operations or actions by virtue of having software, firmware, hardware, or a combination of them installed on the system that in operation causes or cause the system to perform the actions. One or more computer programs perform particular operations or actions by virtue of including instructions that, when executed by data processing apparatus, cause the apparatus to perform the actions. One general aspect includes a system. The system also includes a first component subsystem that may include a first control circuit that is communicatively coupled to one or more data acquisition modules that are associated with respective functional parameters of at least one of a plurality of vehicles that define a vehicle system. The component subsystem collates functional data streams from the data acquisition module and identifies one or more functional anomalies based at least in part on both functional data in the functional data streams and reference functional data from a datastore. The system also includes a central hub capable of interfacing with one or more of a plurality of component subsystems including the first component subsystem. The central hub may include a second control circuit to determine a functional state of the vehicle system based at least in part on the functional data pertaining to the identified one or more functional anomalies. The system also executes a verification routine to validate or ignore the identified one or more functional anomalies. The functional state defines a parameter of the verification routine. Other embodiments of this aspect include corresponding computer systems, apparatus, and computer programs recorded on one or more computer storage devices, each configured to perform the actions of the methods.

In various embodiments the subject matter described herein relates to a system. The system also includes a central hub that interfaces with component subsystems that monitor the operation of a plurality of vehicles of the vehicle system by identifying discrepancies in functional data streams associated with the operation of the plurality of vehicles of the vehicle system. The central hub may include a control circuit to compile the identified discrepancies, determine a functional state of one or more vehicles of the plurality of vehicles of the vehicle system associated with the identified discrepancies, execute a verification routine to validate or ignore the identified discrepancies and the functional state defines a parameter of the verification routine, and define a hierarchy for the validated discrepancies based at least in part on the functional state of the one or more vehicles. Other embodiments of this aspect include corresponding computer systems, apparatus, and computer programs recorded on one or more computer storage devices, each configured to perform the actions of the methods.

In various embodiments the subject matter described herein relates to a method. The method includes collating functional data streams received from data acquisition modules associated with component subsystems on board a plurality of vehicles of a vehicle system, identifying one or more functional anomalies in the functional data streams, generating contextual data relevant to the identified one or more functional anomalies, and validating or ignoring the identified one or more functional anomalies based at least in part on the contextual data.

### BRIEF DESCRIPTION OF THE FIGURES

FIG. 1 is a schematic diagram of a system for monitoring and anomaly detection according to an embodiment of the disclosure.

FIG. 2 is a schematic diagram illustrating the architecture of a system for monitoring a vehicle or vehicle system, including hub agents, component agents, and data flow to third-party systems according to an embodiment of the disclosure.

FIG. 3 illustrates a vehicle control system according to an embodiment of the disclosure.

FIG. 4 is a schematic view of a train parking or movement verification and monitoring system according to an embodiment of the disclosure.

FIG. 5 is a flow diagram of a method for real-time asset inventory acquisition and anomaly detection according to an embodiment of the disclosure.

### DETAILED DESCRIPTION

A system and method provide monitoring, detecting, and responding to anomalies in operational technology (OT) systems of vehicles. In one embodiment, a vehicle hosts a cybersecurity solution that integrates functional data collection, anomaly detection, and monitors for anomalies for security purposes. Suitable vehicle may include rail vehicles, automobiles, mining and industrial vehicles, and over the road trucks. Suitable rail vehicles may include locomotives, switchers, shunters, and the like.

Various embodiments of this disclosure describe a software-based system that handles or automates the real-time or near real time acquisition of asset inventory information and generates actionable security alerts from vehicle control systems. The system may include component subsystems deployed on various control systems or devices within a vehicle for collecting operational data, providing device status, and reporting any anomalies to a central hub. The central hub aggregates data from the component subsystems, performs anomaly detection, and communicates actionable alerts to third-party systems. The system, in one embodiment, integrates with existing platforms, such as mobile data centers, onboard communication systems, and in the context of rail vehicles, onboard communication and train management systems. The system may support third-party security tools and offer modular extensibility. The system may enable real-time or near real-time monitoring, reduce alert overload, and enhance the visibility of select components in the vehicle while reducing or minimizing functional impact.

Various embodiments of this disclosure describe a system and a method for monitoring one or more data streams acquired from a vehicle, vehicle control systems, or vehicle devices. In one aspect, elements of the disclosure may support security operations, mechanical or maintenance operations, asset management, or regulations compliance of a vehicle or vehicle system. In another aspect, the monitoring system and method disclosed herein may generate a filtered set of alerts or event notifications that may be automatically acted upon or remediated or delivered in a human-readable format to a vehicle operator or technician.

Various embodiments of this disclosure describe a system that may include at least one component agent and at least one hub agent working in a coordinated manner for automating real-time acquisition of asset inventory data and generating critical security alerts for locomotive control systems. A component agent interacts directly with a vehicle component or vehicle subsystem while a hub agent collates and analyzes information streamed from a plurality of component agents. In one aspect, a hub agent filters collected information to generate a plurality of alerts. In one aspect, an alert may correspond to a functional anomaly in the vehicle or vehicle system.

The system may integrate at least one of the component agents deployed on various vehicle devices and a hub agent that monitors, collects, and routes data to third-party provided systems. This modular solution enables the integration of third-party security tools and seamlessly interfaces with existing third-party platforms. In one embodiment, the component agents are deployed on individual locomotive devices to continuously collect functional data, monitor device status, and report anomalies to the hub agent. In one embodiment, the hub agent aggregates data from the component agents, performs anomaly detection, and communicates alerts to third-party systems. The hub agent may reside or be hosted in mobile data centers, and may communicate via onboard communication systems or other supplied hardware.

Various embodiments of this disclosure describe algorithms for detecting anomalies by monitoring various parameters for anomalies. Suitable parameters include asset removal, device failure, unauthorized access, and/or select configuration changes. Asset removal triggers an alert when a device or card is unexpectedly removed from the network. Device failure generates an alert when a component fails to respond or reports abnormal functional data. Unauthorized access triggers an alert in response to a failed login attempt, unexpected network traffic, and unauthorized port access. Configuration changes alerts are triggered when there are unexpected changes to configuration files or software versions. These parameters may be coupled with other factors or contextual data, such as whether the vehicle is in motion, is in a determined location, or the like. Another factor may include the time of day, the absence of a scheduled maintenance period, the proximity of an authorized operator (or lack thereof), the type of authentication used, and the like. Types of authentication may include biometric identification, passwords, multi-factor authentication, dongles or physical counterparts, physical lock/key devices, and the like.

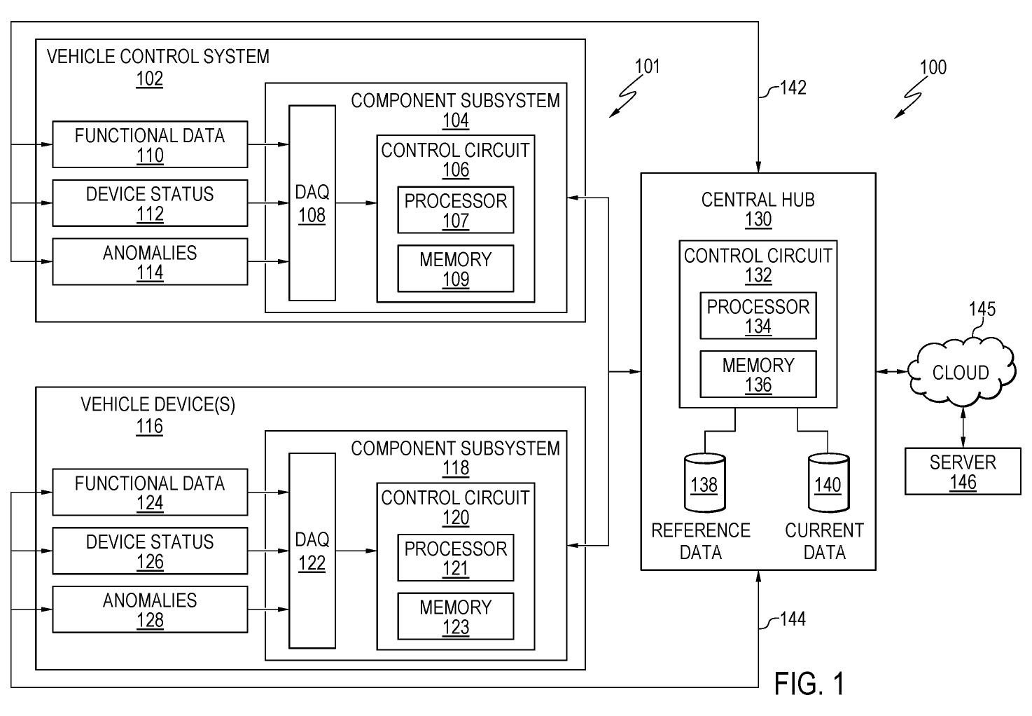

Turning to FIG. 1, one embodiment of the present disclosure describes a monitoring system 100 for real-time monitoring of vehicle systems 101, and in one embodiment, locomotive control systems. The vehicle system may include a vehicle control system 102 or vehicle devices 116. In various embodiments, the vehicle control system includes a component subsystem 104 with a control circuit 106 communicatively coupled to one or more data acquisition modules 108 for collating functional data 110, device status 112, and / or anomalies 114 from the vehicle control system. The control circuit may include a processor 107 and a memory 109 for storing and executing software instructions. In various embodiments, the term communicatively coupled may include a wired connection, a wireless connection, or both, selected with reference to the end use application.

The vehicle systems may include vehicle devices. In various embodiments, the vehicle devices include a component subsystem 118 with a control circuit 120 communicatively coupled to one or more data acquisition modules 122 for collating functional data 124, device status 126, and / or anomalies 128 from the vehicle devices. The control circuit may include a processor 121 and a memory 123 for storing and executing software instructions.

An embodiment of the monitoring system may include a central hub 130 with a control circuit 132 capable of interfacing with one or more component subsystems and determining the functional state of the vehicle control system and/or vehicle devices based on functional data, device status, and / or anomalies. The control circuit may further generate or obtain contextual data relevant to identified functional anomalies and use the contextual data in a verification routine. The contextual data may be derived from the functional state of the vehicle control system or vehicle devices. The identified functional anomalies may include a vehicle-access anomaly, and the verification routine may ignore the anomaly if the vehicle is in an inactive state. The control circuit may modify 142, 144 the vehicle system's functional configuration based on verification routine outputs. The functional state of the system may be determined based on location-based events or movement-based events identified in the functional data streams. The control circuit may include a processor 134 and a memory 136 for storing and executing software instructions. In addition, the central hub may include a reference database 138 for storing reference data and a current database 140 for storing current data obtained from the data acquisition units. The reference and current data may include functional data, device status, and / anomalies. Verification may include comparing reference data stored in the first database with current data stored in the second database to identify functional anomalies. The central hub is in communication with a server 146 portion of a back-end infrastructure. The central hub may communicate with the server over the cloud 145.

One embodiment of the present disclosure describes a method for real-time monitoring and anomaly detection. The method includes collating functional data streams from data acquisition modules associated with component subsystems. The method may further include identifying functional anomalies in the data streams. The method may further include generating contextual data relevant to the anomalies. The method may further include verifying or ignoring anomalies based on the contextual data. The method may further include transmitting validated anomalies to third-party systems for further action.

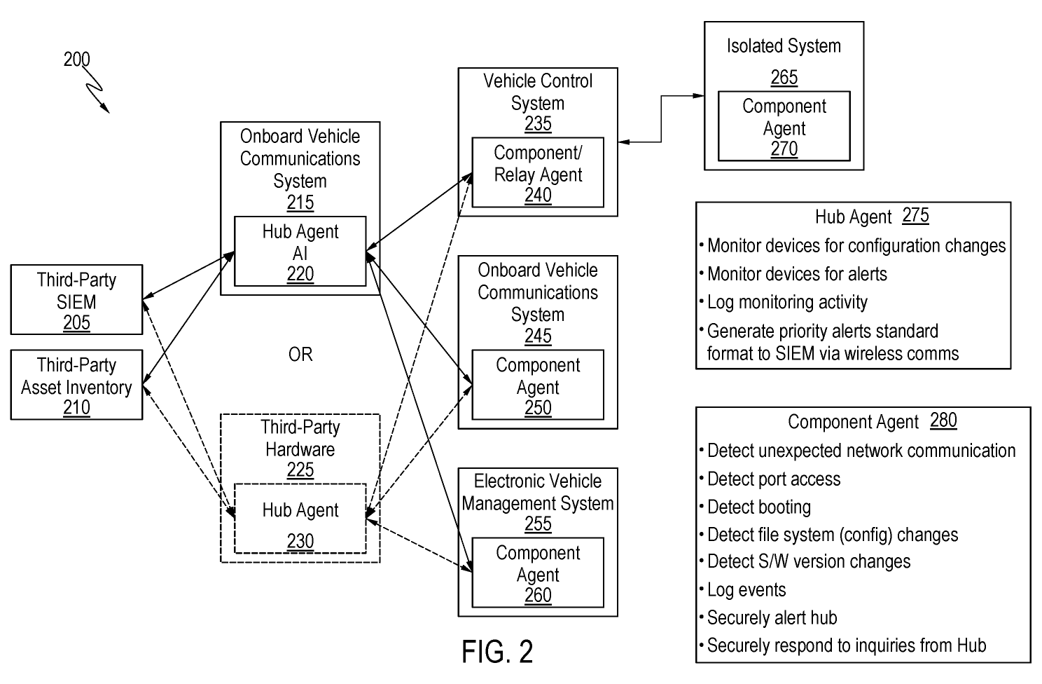

FIG. 2 is a schematic diagram illustrating one embodiment of an architecture of a monitoring system 200 for monitoring a vehicle or vehicle system. The monitoring system may include one or more hub agents 275, component agents 280, and data flow to third-party systems. A first artificial intelligence (AI) hub agent 220 may reside in an onboard vehicle communications system 215. Alternatively, or additionally in other embodiments, a second hub agent 230 may reside on third-party hardware. Each of the hub agents communicates with a third-party SIEM system 205 and a third-party asset inventory system 210. Additionally, the hub agents may communicate with a component / relay agent 240 portion of a vehicle control system 235, a component agent 250 of an onboard vehicle communications system 245, and a component agent 260 of an electronic vehicle management system 255. The vehicle control system may communicate with a component agent 270 in an isolated system 265. Other onboard vehicle hub agents or component agents may be integrated in a similar fashion.

The onboard vehicle communications system may be a network, communication, and application management platform specifically configured for a railroad environment. It may serve as a mobile data center, with processing capabilities, wireless communication, networking, video, and data storage. The system may interface seamlessly with both locomotive and third-party systems, featuring onboard wireless capabilities that facilitate efficient data transfer.

The onboard vehicle communications system may be modular and flexible, and may be ruggedized to withstand the harsh conditions typical in railroad operations. The system supports the execution of customer-specific, locomotive, and third-party applications, enhancing functional efficiency. In one embodiment, the onboard vehicle communications system may be Wabtec’s GoLINC onboard vehicle communication system. The onboard vehicle communications system may incorporate high-precision Global Navigation Satellite System (GNSS) receivers. These receivers, or equivalent devices, may provide accurate positioning information. Other positioning capability that can be used may be LIDAR, time-of-flight detectors, video cameras (stereoscopic or otherwise), and the like. The ability to position, and from that to navigate, may be beneficial in several applications. One example may be in autonomous or drone (remotely piloted) vehicles.

The electronic vehicle management system may be a specific implementation of positive vehicle control, in which real-time monitoring, movement enforcement, interoperability, and data integration may be provided. Where the term “real-time” is used, in each instance that is inclusive of near-real-time. In real-time monitoring the system continuously tracks train location, speed, and functional parameters using navigational and positioning features. In an exemplary use case, if a train operator fails to take corrective action when a need is detected, the system may automatically apply the remedy appropriate for that need. As a more specific example, if a vehicle is on course for a collision and the operator does not begin to slow or to turn, the system may apply the vehicle brakes to prevent an accident. The system may be interoperable so as to work across different railroads (in the case of a train or locomotive). As such, it may help to ensure seamless communication management for plural trains that are operating on shared routes. The system may collect and combine data from signal devices, switches, and other wayside devices with inputs from the vehicles (that are operating on those tracks) to provide precise situational awareness at a macro-level. A suitable electronic vehicle management system may be Wabtec’s Interoperable Electronic Train Management System (I-ETMS) overarching framework.

The onboard vehicle communications system integrates with the electronic vehicle management system. This may facilitate functioning as an overlay designed. This overlay may enforce existing railroad signal indications and other operating rules. The integrated configuration may provide useful information. Such useful information may include work zone proximity, movement authorization, switch positions, and other functional data, thereby enhancing functional efficiency.

Referring back to the overall monitoring system, various hub agents hosted by various vehicle subsystems may orchestrate various component agents and collect, collate, and analyze data from the various component agents. In some embodiments, the various hub agents may send various event descriptions, metadata, notifications, or alerts to various display systems, alert or event management systems, asset or inventory management systems, or other data aggregator systems. For example, as shown in FIG. 2 by way of example, the hub agents are in communication with a third-party SIEM system and a third-party asset inventory system. In other embodiments, various hub agents may support auto-remediation of functional anomalies. In various embodiments, a hub agent may be hosted on, for example, a general-purpose computer, a vehicle computer or computer system, a railroad computer system such as a GoLINCsystem or third-party-provided hardware 225. In some embodiments, a GoLINC system may function as a mobile data center that provides processing capabilities, wireless communication, networking, video, and data storage.

A hub agent may monitor, collect, and collate data from the various component agents through queried/polled (pull) or event-driven (push) methods. The hub agent may intelligently disseminate alert data and deliver actionable alerts and event feeds to monitoring systems, databases, and configuration management systems in the back-end infrastructure. Through push/pull event monitoring, the hub agent employs events to determine anomalous or unusual activity. The hub agent may create alerts based on information obtained from component agents. The hub agents may push alerts to specified endpoints for consumption and actions and generate priority alerts to the third-party SIEM, translating event data to industry standard logging formats.

Alerts created by the hub agents may include highly actionable alerts such as rouge asset detection, asset removal, device failure notifications, failed authentication attempts, firmware/software/configuration changes, communication interruptions, unexpected communication, and/or GPS spoofing. Examples of highly actionable alerts are described below.

Rogue asset detection alerts, for example, may indicate that a new device is added to the vehicle, such as the insertion of media or other peripherals. This alert is triggered if a new device is discovered after the system is automatically (after a defined period) or manually “baselined” as nominal. Rogue asset detection alerts may be triggered based on detecting rogue assets such as, for example, source devices, network devices, network protocols, log file type, time stamp, access method, alert category, and/or alert criticality.

Asset removal alerts, for example, may indicate when a device is removed from the vehicle while in operation. This alert is triggered if the hub agent is no longer receiving updates or heartbeats from a component agent, after a defined period. This may be further limited to only trigger if there is a “baseline” set, and this device was part of that baseline. Asset removal alerts may be triggered based on removal of assets such as, for example, source devices, network devices, network protocols, log file type, time stamp, access method, alert category, and/or alert criticality.

Device failure notifications alerts, for example, may indicate an attack to disrupt normal operation through excessive resource consumption. Similar to the asset removal alert, a device failure notifications alert may be triggered if the hub agent is no longer receiving updates or heartbeats from a component agent after a set period. Device failure notifications alerts may be triggered based on the receipt of certain failure events from the component agent. Failure notification alerts may be triggered based on failures of source devices, network devices, network protocols. The notices may include information such as log file type, time stamp, access method, alert category, and/or alert criticality.

Failed authentication attempt alerts, for example, may indicate multiple authentication failures within a short period. Failed authentication attempts alerts may be triggered based on receipt of a failed authentication event from the component agent. Failed authentication attempt alerts may be triggered while attempting to authenticate devices. These devices may be source devices, network devices, or other types of devices selected based on end use parameters. The alerts may include information about network protocols that are being employed, log file type, time stamp, access method, alert category, and/or criticality.

Alerts associated with modifications in firmware/software/configuration may indicate when or if a change in software or configuration occurs under certain circumstances. An example circumstance may be while the vehicle is in motion. Other circumstances may include those where a configuration change is not expected or is not desirable. The alerts associated with modifications in firmware/software/configuration may be triggered by changes in a software/configuration fingerprint. Example changes may include a change in version, checksum, a change in software/configuration load, or a change event notice received from the component agent. Firmware/software/configuration changes alerts may be associated with source devices, network devices, and network protocols. And the alerts may contain information to include log file type, time stamp, access method, alert category, and/or criticality.

Communication interruptions alerts, for example, may indicate failure due to excessive network traffic or may be indicative of a denial-of-service attack. Communication interruptions alerts may be triggered if the hub agent is no longer receiving updates or heartbeats from a component agent after a determined period. A confirmation response may include a network ping verification or the like. This confirmation action may be triggered by a “loss of communication” event received from the component agent. Communication interruptions alerts may be triggered by an interruption in communication with, for example, source devices, network devices, and the like. And the alert may include information related to network protocols, log file type, time stamp, access method, alert category, and/or criticality. The determined period before the system requests confirmation or sends an alert may be set in advance, may be determined based on application specific parameters, or may be dynamically determined such that in some circumstances the period differs from others, such as the criticality of the device, the environmental factors, and the history associated with the situation. Historical or reference determinations may be appropriate if there has never been an issue before (longer period) or if there has been an increasing number of instances recently (indicating a higher likelihood of a problem and shorter period before requesting confirmation).

Unexpected communication alerts, for example, may indicate when a device sends or receives messages from an unanticipated device, which may be indicative of a man-in-the-middle. Unexpected communication alerts may be triggered in one of two ways. The hub agent may monitor the IP and MAC addresses of the component agent, and if this MAC address ever changes, then it would trigger the unexpected communication alert. Also, the component agent may do the same with all communication to itself with other devices and send an event to the hub agent. Unexpected communication alerts may be triggered by unexpected communication with, for example, source devices, network devices, and the like. Alerts may carry information relating to the network protocols, log file type, time stamp, access method, alert category, and/or criticality. One way of detecting unexpected communications may include, for example, receiving IP-based messages for a UDP or TCP port that is not or was not enabled. Such messages could represent probing from an unauthorized source.

Navigational issues, such as GPS spoofing, for example, may indicate when a false location or time stamp is leveraged to impact GPS dependent operations. The determination of a navigational issue may result in the generation of a GPS alert, and that may be triggered when GPS data (position or time data) changes more than a threshold amount within a determined period. GPS spoofing alerts may be triggered based on drastic or dramatic changes in position or time data of devices that would be beyond expectations for known vehicle types and operations. A vehicle moving instantaneously over several kilometers, for example, indicates an error of some sort.

A component agent may reside in a location selected with reference to end use parameters. Suitable devices that can host a component agent may include an individual vehicle control system or device, a GoLINCsystem, an I-ETMS system, a Trip Optimizer system, a bespoke electronic system, a mobile device, an isolated or static system, or even on another vehicle in another vehicle system. A component agent may continuously collect functional data and status events or descriptions of a system on which the component agent resides. Furthermore, in many embodiments, a component agent may send heartbeats, pings, connectivity checks, or other routine, continuous communications to a hub agent.

The component agent may detect and report information on its "host" component/system to the hub agent. The component agent’s primary function may be to gather and deliver asset inventory data on its “host” component and continuously monitor and report on this system’s functional statuses to the hub agent. These alerts may leverage the vehicle manufacturer institutional knowledge of the functional behavior of covered devices within the onboard vehicle control system. A comprehensive asset inventory data requirements list is described below. The component agent’s secondary function may be to act as a relay for the hub agent in the case where the component has connectivity to other networks or components not accessible to the hub agent. In this situation, the component agent detects this topology, and relays asset inventory and events messages between the hub agent and the “remote” components.

The following example list of asset inventory is a prioritized list of requirements. As an example, a user may select as a top or first priority a device MAC address (logged on discovery), IP Address (logged on discovery), a Component Manufacturer/Make/Model (Product/Sub-product/Product Version), Software/Firmware/OS List, Name/Function, Version, Checksum (CRC/Hash), Installed Date/Time, Asset identifier, for example Vehicle Identifier (as the component refers to itself), and/or location. And, the user may select as a second priority one or more of a Hardware serial number, Physical Network Interfaces (Names, ETH0), TCP/UDP/IP Ports and Protocols w/Interface Name, VLAN w/ Interface Name, Network Topology (relevant if the device used LLDP, such as a network switch), Software Licenses (Open source), Agreed on SBOM (Software Bill of Materials), User Accounts and roles, and/or Authentication/Authorization Mechanism. Tertiary and more levels may be applied as well. Further, the user may set a dynamic selection such that a data item may be first priority in some situations, but a secondary in other situations. The situation may be an operational designation for a vehicle or device so that if the vehicle is a lead vehicle in a group (convoy, platoon, swarm, consist, etc.) it may use that status to dynamically determine which aspects are first and which are second.

The monitoring system illustrated in FIG. 2 may communicate with back-end infrastructure (e.g., back office) and wayside devices through various communication paths. The system has a network agnostic configuration and uses available central monitoring and reporting system communication paths of its host network. Alerts, logs, and asset inventory data will be used to communicate with the back-end infrastructure. Due to the variation of the vehicle configuration, the system maintains connectivity regardless of the backhaul medium available, leveraging existing vehicle communication systems. Suitable communication devices may include radios (e.g., 220 MHz radio), cellular and Wi-Fi devices, and the like. In one embodiment, the system configuration considers communication robustness including acceptable limits for packet loss, latency, and bandwidth limitations, including redundancy for communication path and hub agents.

The monitoring system illustrated in FIG. 2 may detect and report functional anomalies of a vehicle or vehicle system. A functional anomaly may include, for example, a presence of a rogue asset, an asset removal event, a device failure event, a failed authentication attempt, a configuration change event, a communication interruption event, an unexpected communication, abnormal global positioning system (GPS) data, or other security-related or abnormal events. In various embodiments, an alert or notification of any of the above events may include various fields or metadata, such as a source device indicator, a network device indicator, a network protocol, a log file type, a time stamp, an access method, an alert category, and an alert criticality.

A rogue asset may include storage media or other peripheral devices. A detection of a rogue asset may occur after a system baseline or a functional reference state has been established. In some embodiments, a system baseline or a functional reference state may be established manually or automatically according to specific system criteria or after a certain duration of time has elapsed.

An asset removal event may indicate when a device is removed from a vehicle when it is in operation or is moving. An asset removal event may be detected if a component agent does not send heartbeats, pings, or other routine communications to a hub agent within a determined time interval or if the component agent fails to respond to requests from the hub agent. In some embodiments, a notification of an asset removal event may only occur if a removed device is included in a system baseline or functional reference state.

A device failure event may be detected if a component agent does not send heartbeats, pings, or other routine communications to a hub agent within a pre-defined time interval. In other embodiments, a component agent may send failure messages to a hub agent. In some embodiments, a device failure may correspond to an attack to disrupt normal vehicle operation through excessive resource consumption.

A failed authentication attempt may correspond to multiple failures within a short period. A failed authentication attempt may be detected based on a notification from a component agent.

A configuration change event may trigger if a software, firmware, or other configuration changes occur. In some embodiments, a configuration change may be detected based on a change in a configuration checksum, cyclic redundancy check (CRC), fingerprint, hash, or version. A component agent may also signal a configuration change. In some embodiments, a configuration version, checksum, fingerprint, or other state indicator may be included in a system baseline or functional reference state. In other embodiments, a configuration change event may trigger only while a vehicle or vehicle system is in motion, in a particular geographic location, or according to other pre-defined criteria.

A communication interruption event may trigger if component agent does not send heartbeats, pings, or other routine communications to a hub agent within a pre-defined time interval. A communication interruption event may trigger if a component agent explicitly indicates a communication interruption. In some embodiments, a communication interruption event may occur in a presence of excessive network traffic caused by, for example, a denial-of-service (DoS) attack.

An unexpected communication event may trigger based on a variety of criteria. For example, an unexpected communication may comprise a message originating from a first internet protocol (IP) address and a first hardware address or media access control (MAC) address combination wherein the first IP address was previously associated with a second MAC address. An IP address / MAC address mismatch may be observed by a component agent, hub agent, or other network device. In some embodiments, an IP address / MAC address mismatch in a network message or other unexpected origination of a network message may indicate a man-in-the-middle attack.

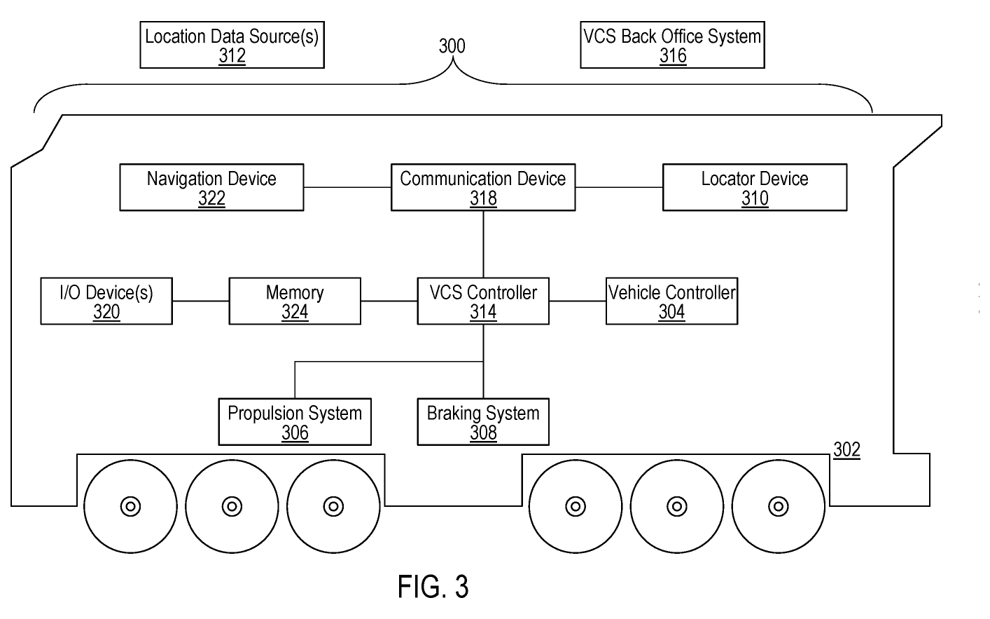

FIG. 3 illustrates one embodiment of a vehicle control system 300 deployed onboard a propulsion vehicle 302. The vehicle control system in FIG. 3 may represent the architecture of the system shown in FIGS. 1 and 2 for monitoring a vehicle or vehicle system, including hub agents, component agents, and data flow to third-party systems. In the system, various hub agents hosted by various vehicle subsystems may orchestrate various component agents and collect, collate, and analyze data from the various component agents. In some embodiments, the various hub agents may send various event descriptions, metadata, notifications, or alerts to various display systems, alert or event management systems, asset or inventory management systems, or other data aggregator systems. For example, hub agents are in communication with a third-party SIEM system and a third-party asset inventory system. In other embodiments, various hub agents may support an auto-remediation of functional anomalies. In various embodiments, a hub agent may be hosted on, for example, a general-purpose computer, a vehicle computer or computer system, a railroad computer system such as the vehicle onboard vehicle communication systems as shown in FIG. 2, which in one embodiment may be a GoLINC system, or other third party-provided hardware. One or more components of the vehicle control system may be off board the vehicle while one or more other components of the vehicle control system may be on-board the vehicle. Off board components may be located wayside of the route or may be located in a back office. Alternatively, all components of the vehicle control system may be on-board the vehicle. The components, as software, may be dynamically allocated based on need. If, for example, an off-board hosted system may have communication issues then an onboard system may assume responsibility. This situation may occur when a back-office component provides more computing power and rich feature set but may be redundant with a feature poor but more portable version that can be carried on board the vehicle.

A vehicle control circuit 304 may control the operation (e.g., movement) of the vehicle. The vehicle controller may represent hardware circuitry that includes and/or is connected with one or more processors (e.g., microprocessors, integrated circuits, field programmable gate arrays, etc.) that perform the operations described in connection with the vehicle controller. For example, the vehicle controller may communicate with a propulsion system 306 ("Prop. System" in FIG. 3, such as one or more engines, motors, or the like) to control propulsion of the vehicle and vehicle system, and/or a braking system 308 (e.g., one or more friction brakes, air brakes, or the like) to slow or stop movement of the vehicle and vehicle system. In other embodiments, the vehicle controller, or control circuit, may be implemented in logic, such as, a programmable logic device (PLD) or field programmable gate array (FPGA), for example.

A locator device 310 may determine the geographic locations of the vehicle. In one embodiment, the locator device communicates with one or more location data sources 312 that are off board the vehicle to determine the locations of the vehicle and a leading edge of the vehicle. For example, the location data sources may represent GNSS satellites or beacons that broadcast signals that are received by the locator device (e.g., a GNSS or GPS receiver). The locator device may determine the location, heading, speed, etc. of the vehicle based on these signals. Alternatively, the locator device may include a sensor that detects one or more characteristics to determine the locations of the vehicle. For example, the locator device may represent a radio frequency identification (RFID) reader that reads an RFID tag associated with a known location to determine the vehicle location. As another example, the locator device may represent an optical sensor, such as a camera, that optically reads where the vehicle is located (e.g., from one or more signs, such as waypoints, road signs, etc.). In one example, the locator device (and/or the vehicle controller) may apply one or more filters to the signals received from the location data source(s), such as a Kalman filter.

A vehicle control system controller 314 ("VCS Controller" in FIG. 3) may represent an onboard component of the vehicle control system, such as, for example, the vehicle control system as shown in FIG. 2. The VCS controller may communicate with an off-board component of the vehicle control system, such as a vehicle control system back-office system 316 ("VCS Back Office System" in FIG. 3) such as the isolated system shown in FIG. 2. The VCS controller and the back-office system may communicate with each other via a communication device 318 (shows in FIG. 3), which may represent hardware transceiving circuitry, such as a transceiver, modem, antenna, and the like. The back-office system also may include a communication device to allow for communication with the vehicles. The VCS controller may represent hardware circuity that includes and/or is connected with one or more processors. The VCS controller may communicate with the back-office system to report locations of the vehicle, moving speeds of the vehicle, headings, or directions of movement of the vehicle, etc. The VCS controller also may receive directive signals from the back-office system. These signals may include movement restrictions, such as movement authorities that dictate where, when, and/or how the vehicle may move. The back-office system may determine whether to allow different vehicles to enter into different route segments and/or how the vehicles may move in those segments based on reported locations, speeds, and/or headings of the vehicles, as well as reported areas of the routes undergoing repair, maintenance, etc.

For example, the back-office system and the VCS controller may be components of a positive control system that sends movement authorities to vehicles to inform the vehicles whether the vehicles may travel into an upcoming segment of a route, how fast the vehicles may move in the upcoming segment of the route, etc. If the VCS controller receives a permissive movement authority from the back office system indicating that the vehicle may enter into the upcoming segment, then the VCS controller may inform the operator (e.g., via an input and/or output device 320, or "I/O Device" in FIG. 3) of whether the vehicle may move into the upcoming segment (and optionally how fast the vehicle may move in the upcoming segment). Optionally, the VCS controller may allow the vehicle to move into the upcoming segment responsive to receiving the movement authority. But if the VCS controller does not receive the movement authority, then the VCS controller may inform the operator of the vehicle and/or generate signals to automatically control the propulsion system and/or braking system to prevent the vehicle from entering into the upcoming segment of the route and/or to prevent the vehicle from moving in the upcoming segment of the route in a way that violates the movement authority (e.g., moving faster than the movement authority dictates).

As another example, the back-office system and the VCS controller may be components of a negative control system that sends movement authorities to vehicles to inform the vehicles where the vehicles cannot travel. If the VCS controller receives a movement authority from the back-office system indicating that the vehicle cannot enter into the upcoming segment, then the VCS controller may inform the operator and/or automatically control the propulsion system and/or braking system to prevent disallowed movement of the vehicle in the upcoming segment. If the VCS controller does not receive the movement authority from the back-office system indicating that the vehicle cannot enter into the upcoming segment, then the VCS controller may inform the operator and/or allow movement of the vehicle in the upcoming segment.

A navigation device 322 may determine locations of the vehicle based off information other than or in addition to the off-board signals received from the location data source(s). For example, the navigation device may include or represent one or more sensors that detect movement of the vehicle. These sensors may include one or more IMUs, accelerometers, magnetometers, tachometers (e.g., wheel and/or other tachometers), etc. The navigation device optionally may include one or more processors that examine the information sensed by the sensors to determine the movement and/or change in location of the vehicle. Alternatively, the navigation device may include the sensor(s) but may send the output from the sensor(s) to the VCS controller and/or the vehicle controller to calculate the location of the vehicle based on the sensor output. The navigation device and/or the vehicle controller may apply one or more filters, such as a Kalman filter, to the output of the sensor(s). In one embodiment, the navigation device (or the controller(s)) may employ a dead reckoning calculation, a wireless triangulation calculation, or the like, to monitor or determine the location(s) of the vehicle in locations and/or during times when the locator device is unable to do so and/or the locator device is unable to receive the signals from the location data source(s). In one embodiment, a locator device may determine a position uncertainty based on data and errors.

The I/O device referred to above may represent a display screen, a touchscreen, a speaker, or the like, which is used to communicate information with an operator onboard the vehicle. A tangible and computer-readable storage medium (e.g., a computer hard drive, disc, removable memory, etc.), or memory 324, optionally may be onboard the vehicle. This memory may store information determined by the navigation device, controller(s), and/or locator device, such as a last-known location determined from the off-board signals received from the location data source(s), the location determined by the navigation device or controller(s) based on the output from the navigation device (e.g., the dead-reckoning determined location), or the like. The memory optionally may store route layouts, such as a map or other information on the locations, curves, paths, etc. of various routes on which the vehicle may or will travel.

In operation, one embodiment of the control system may initiate a trip of the vehicle (or a multi-vehicle system that includes the vehicle) by obtaining one or more off-board signals from the location data source(s) and determine the geographic location of the vehicle. The VCS controller may examine this location and the route layouts (e.g., as obtained from the memory and/or received from a communication from the back-office system) to determine which route the vehicle is located. For example, the VCS controller may determine whether the geographic location of the vehicle as determined by the locator device is on or near a route (e.g., within a threshold distance, such as three meters or a distance between neighboring routes). The VCS controller may identify this route as the route currently occupied by the vehicle and on which the vehicle will begin the trip. The VCS controller may communicate this identified route to the back-office system so the back-office system may determine where the vehicle is located to determine which route segments that the vehicle may enter into, how fast the vehicle may move through the route segments, and the like.

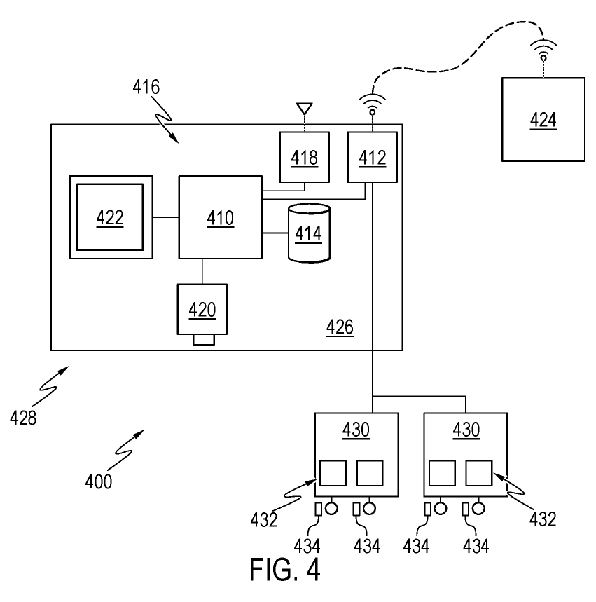

As illustrated in FIG. 4, a system 400 uses system architecture to support the functionality of at least some of the methods and systems described herein. The system includes a train management computer or on-board computer 410 (which performs calculations for or within the Positive Train Control (PTC) system, including navigation calculations and may be located a control vehicle 426 (L)), a communication device 412 or data radio (which may facilitate communications between the on-board computers in the control vehicle (L) of a train 428 (TR), communications with a wayside device, e.g., signals, switch monitors, and the like, and/or communications with a remote server, e.g., a back office server, a central controller, central dispatch, and/or), at least one database 414 (which may include information about the train or its operating parameters, track positions or locations, switch locations, track heading changes, e.g., curves, distance measurements, train information, e.g., the number of locomotives, the number of vehicles, the number of conventional passenger vehicles, the number of control vehicles, the total length of the train, the specific identification numbers of each locomotive or control vehicle (L) where PTC equipment (e.g., an on-board computer) is located, and the like), and a navigation system 416 (optionally including a positioning system 418 (e.g., a Global Positioning System (GPS)) and/or a wheel tachometer/speed sensor 420). In addition, an operator interface 422 (e.g., an interactive display, a computer screen, a computer monitor, a display in communication with an input device, a display device, a display mechanism, and the like) is provided and in direct or indirect communication with the on-board computer 410 for displaying information and data to the operator/user. With continued reference to the embodiment of FIG. 4, and as discussed above, the locomotive or control vehicle (L) is communication with the rail vehicles 430 (R) over the Trainline (TL) and/or through wireless communication. Some or all of the rail vehicles (R) are equipped with an air brake arrangement 432 (ABB), which includes a hand brake arrangement 434 (HB).

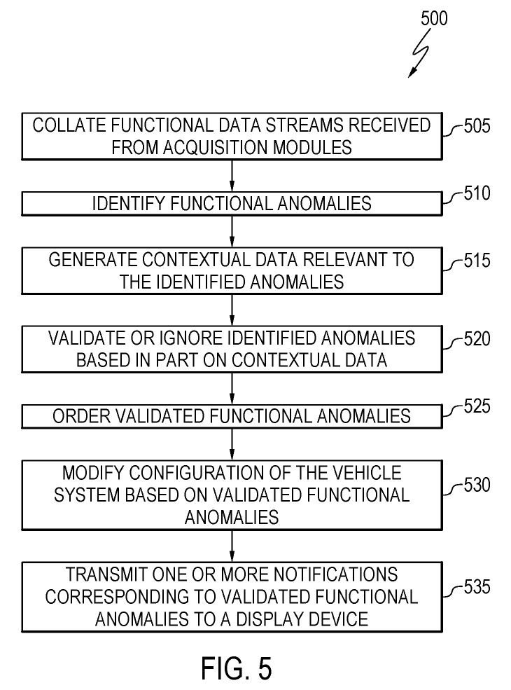

FIG. 5 is a flow diagram of one embodiment of a method 500 for real-time asset inventory acquisition and anomaly detection. The method may include collating (step 505) functional data streams received from acquisition modules. An acquisition module may be a component agent or may be contained within a component agent. A vehicle or vehicle system may comprise multiple acquisition modules and therefore the method disclosed herein comprises a method of collating various data streams from various acquisition modules. In many embodiments, data streams include descriptions of functional states, asset inventory, software versions, and network activity. The method also may include identifying (step 510) functional anomalies. In various embodiments, a hub agent may compare current functional data with reference data stored in a data store to identify functional anomalies. The method also may include generating (step 515) contextual data relevant to identified anomalies. In some embodiments, a functional context of a vehicle may include a location, a speed, or another functional state. The method also may include (step 520) validating identified anomalies based in part on contextual data and de-prioritizing or ignoring identified anomalies that are not validated. The method also may include (step 525) in which a hierarchy is created via the ordering or prioritizing validated anomalies. The method for real-time asset inventory acquisition and anomaly detection disclosed herein may comprise an auto-remediation of identified and validated functional anomalies. An auto-remediation may include modifying (step 530) of a configuration of a vehicle or vehicle system. Finally, the method may include transmitting (step 535) one or more notifications corresponding to validated functional anomalies to a display device or third-party security information and event management (SIEM) system. After a transmission of alerts or notifications to a display device or SIEM system, a human operator or other system may further analyze and act upon validated functional anomalies.

As illustrated schematically in FIGS. 1-5, the present disclosure describes a system of one or more computers that may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general embodiment includes a system. The system also may include a first component subsystem that may include a first control circuit that is communicatively coupled to one or more data acquisition modules that are associated with respective functional parameters of at least one of a plurality of vehicles that define a vehicle system. The component subsystem collates functional data streams from the data acquisition module and identifies one or more functional anomalies based at least in part on both functional data in the functional data streams and reference functional data from a datastore. The system also includes a central hub capable of interfacing with one or more of a plurality of component subsystems including the first component subsystem. The central hub may include a second control circuit to determine a functional state of the vehicle system based at least in part on the functional data pertaining to the identified one or more functional anomalies. The system also includes executing a verification routine to validate or ignore the identified one or more functional anomalies, where the functional state defines a parameter of the verification routine. Other embodiments of this aspect include corresponding computer systems, apparatus, and computer programs recorded on one or more computer storage devices, each configured to perform the actions of the methods.

Implementations may include one or more of the following features. A second circuit of the system generates or obtains contextual data relevant to the identified one or more functional anomalies and applies the contextual data in executing the verification routine. The contextual data is derived, at least in part, based on the functional state. The contextual data may include one or more risk assessment or prioritization value. The second control circuit modifies a functional configuration of the vehicle system based at least in part on an output of the verification routine. The functional configuration of the vehicle system may include at least one of a route of the vehicle system, a movement of the vehicle system, a security configuration of the vehicle system, or a logging procedure of the vehicle system. The identified one or more functional anomalies may include a vehicle-access anomaly. The functional state may include an inactive state where an output of the verification routine is to ignore the vehicle-access anomaly. The second control circuit determines the functional state of the vehicle system based at least in part on location-based events identified within the functional data streams or movement-based events identified within the functional data streams. Implementations of the described techniques may include hardware, a method or process, or computer software on a computer-accessible medium.

One general embodiment includes a system. The system may include a central hub that interfaces with component subsystems that monitor operation of a plurality of vehicles of the vehicle system by identifying discrepancies in functional data streams associated with the operation of the plurality of vehicles of the vehicle system, the central hub may include a control circuit to compile the identified discrepancies, determine a functional state of one or more vehicles of the plurality of vehicles of the vehicle system associated with the identified discrepancies, execute a verification routine to validate or ignore the identified discrepancies, and the functional state defines a parameter of the verification routine, and order the validated discrepancies so that the functional state of the one or more vehicles further defines a parameter of the prioritization routine. Other embodiments of this aspect include corresponding computer systems, apparatus, and computer programs recorded on one or more computer storage devices, each configured to perform the actions of the methods.

Implementations may include one or more of the following features. The control circuit of the system can obtain or generate contextual data relevant to the identified discrepancies and apply the contextual data in executing at least one of the verification routine or the prioritization routine. The contextual data is derived, at least in part, based on the functional state. The contextual data may include one or more risk assessment or prioritization value. The control circuit transmits one or more notifications identifying the validated discrepancies to a display device based on an output of the prioritization routine. The control circuit receives user input from the display device based at least in part on the one or more notifications and modifies a functional configuration of the vehicle system based at least in part on the user input. The functional state of the vehicle system is determined based at least in part on location-based events identified within the functional data streams or movement-based events identified within the functional data streams. Implementations of the described techniques may include hardware, a method or process, or computer software on a computer-accessible medium.

One general embodiment includes a method. The method also may include collating functional data streams received from data acquisition modules associated with component subsystems on board a plurality of vehicles of a vehicle system, identifying one or more functional anomalies in the functional data streams, generating contextual data relevant to the identified one or more functional anomalies, and validating or ignoring the identified one or more functional anomalies based at least in part on the contextual data. Other embodiments of this aspect include corresponding computer systems, apparatus, and computer programs recorded on one or more computer storage devices, each configured to perform the actions of the methods.

Implementations may include one or more of the following features. The method may include ordering the one or more validated functional anomalies. The contextual data may relate to a functional state of one or more vehicles of the plurality of vehicles. Other factors or contextual data may include the time of day, the location of the vehicle, the presence or absence of authorized users, and the like. The method may include modifying a functional configuration of the vehicle system based at least in part on the one or more validated functional anomalies. The method may include transmitting one or more notifications identifying the one or more validated functional anomalies to a display device based on an output of the prioritization routine. Implementations of the described techniques may include hardware, a method or process, or computer software on a computer-accessible medium.

Certain embodiments may include a scalable system for managing the distribution of software updates and alert configurations, and includes a configuration engine supporting third-party alert rule deployment. One such system provides scalable cybersecurity monitoring and configuration management for locomotive control systems. This system comprises a plurality of onboard hub agents that collect software asset inventories and generate alerts. The collected data is transmitted to a back-office relay, which buffers the information between the onboard hubs and enterprise systems. The back-office relay also facilitates the distribution of software updates to the hubs, enabling detection of version discrepancies and triggering updates upon operator acknowledgment.

A method for distributed software update and alert configuration involves managing software and alert rule configurations within a distributed locomotive cybersecurity environment. The method includes receiving data from onboard hub agents, buffering the data prior to its transmission to enterprise systems, and monitoring software versions using MQTT-style messaging protocols. Updates are initiated upon confirmation or acknowledgment from an operator.

A configuration engine for third-party alert rule deployment enables efficient management of security alert rules and supports integration of third-party components in a distributed locomotive cybersecurity platform. This engine includes a user interface that allows operators to create and deploy alert rules without requiring scripting or code development. It also supports the receipt of third-party component agents, the automatic generation of associated alert rules, and the deployment of these rules to onboard hub agents without manual coding.

Embodiments may be described in connection with a vehicle system, and suitable vehicle systems may include rail vehicles, automobiles, trucks (with or without trailers), buses, marine vessels, aircraft, unmanned aircraft (e.g., drones), mining vehicles, agricultural vehicles, or other off-highway vehicles. Suitable rail vehicles may include a locomotive or switcher or shunter. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, functional parameters, vehicle parameters, and route parameters, etc.

Movement of a vehicle system may include propelling the vehicle forward or backward along a direction of travel, as well as slowing or stopping the vehicle. Movement further may include turning left or right and increasing or decreasing elevation or depth. Movement further may include determining or setting a vehicle speed, changing a vehicle speed, and matching speeds and directions between vehicles in a vehicle group. Indirectly, movement of the vehicle may include ramping up (or down) power sources; and this may include energizing electrical circuits or buses, setting fuel flow rates, setting engine RPM rates, and the like.

The terms "control circuit" and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term "non-transitory computer-readable medium" refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network may process sensor data or functional inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, functional input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun, and the equipment directions further modified.

In one embodiment, data can be generated, transmitted, and stored and may involve one or both of a protected space data source and the exposed space data source. The control circuit may encrypt, and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that is intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. Raw data gathered by these sensors may feed into the control circuit, which in turn can respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for functional health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate protocols to reduce or avoid catastrophic failure. Self-diagnostics may use historical or reference performance data to identify trends, facilitating proactive rather than reactive maintenance.

Terms such as "processing," "computing," "calculating," or "determining" refer to operations carried out by the control circuit, which may include computing systems or electronic devices that manipulate data represented as physical (electronic) quantities within memory or registers. One or more components may be described as "configured to," "configurable to," "operable/operative to," "adapted/adaptable to," or similar terms. Unless explicitly stated, these terms encompass components in both active and inactive states. Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system, comprising:
a first component subsystem comprising a first control circuit that is communicatively coupled to one or more data acquisition modules that are associated with respective functional parameters of at least one of a plurality of vehicles that define a vehicle system, the first component subsystem being configured to:
identify one or more functional anomalies based at least in part on both functional data in the functional data streams and reference functional data from a datastore, and
a central hub that interfaces with one or more of a plurality of component subsystems including the first component subsystem, the central hub comprising a second control circuit that is configured to:
determine a functional state of the vehicle system based at least in part on the functional data pertaining to the identified one or more functional anomalies; and
execute a verification routine to validate or ignore the identified one or more functional anomalies, and the functional state defines a parameter of the verification routine.

2. The system of claim 1, wherein the second control circuit is further configured to:
generate or obtain contextual data that is relevant to the identified one or more functional anomalies; and
apply the contextual data in executing the verification routine.

3. The system of claim 2, wherein the contextual data is derived, at least in part, from the functional state.

4. The system of claim 3, wherein the contextual data comprises one or more risk assessment value or prioritization value.

5. The system of claim 1, wherein the second control circuit is further configured to modify a functional configuration of the vehicle system based at least in part on an output of the verification routine.

6. The system of claim 1, wherein the identified one or more functional anomalies comprises a vehicle-access anomaly, wherein the functional state comprises an inactive state, and an output of the verification routine is to ignore the vehicle-access anomaly.

7. The system of claim 1, wherein the second control circuit is configured to determine the functional state of the vehicle system based at least in part on location-based events identified within the functional data streams, or movement-based events identified within the functional data streams.

8. The system of claim 5, wherein the functional configuration of the vehicle system comprises at least one of:
a route of the vehicle system,
a movement of the vehicle system,
a security configuration of the vehicle system, and
a logging procedure of the vehicle system.

9. A system having a control circuit, comprising:
a central hub that interfaces with component subsystems that monitor operation of a plurality of vehicles of a vehicle system by identifying discrepancies in functional data streams associated with the operation of the plurality of vehicles of the vehicle system, the central hub disposed on the control circuit and configured to:
compile or obtain the identified discrepancies;
determine a functional state of one or more vehicles of the plurality of vehicles of the vehicle system associated with the identified discrepancies;
execute a verification routine to validate or to ignore the identified discrepancies as an output of the verification routine, and the functional state defines a parameter of the verification routine; and
determine a hierarchy for the validated or ignored discrepancies based at least in part on the functional state of the one or more vehicles.

10. The system of claim 9, wherein the control circuit is further configured to:
generate or obtain contextual data relevant to the identified discrepancies; and
apply the contextual data in executing at least one of the verification routine or a prioritization routine.

11. The system of claim 10, wherein the contextual data is derived, at least in part, based on the functional state of the one or more vehicles.

12. The system of claim 11, wherein the contextual data comprises one or more risk assessment value or prioritization value.

13. The system of claim 9, wherein the control circuit is further configured to transmit one or more notifications identifying the validated or ignored discrepancies to a display device based on an output of a prioritization routine.

14. The system of claim 13, wherein the control circuit is further configured to:
receive user input from the display device based at least in part on the one or more notifications; and
modify a functional configuration of the vehicle system based at least in part on the user input.

15. The system of claim 9, wherein the functional state of the vehicle system is determined based at least in part on:
location-based events identified within the functional data streams; or
movement-based events identified within the functional data streams.

16. A method comprising:
collating functional data streams received from data acquisition modules associated with component subsystems on board a plurality of vehicles of a vehicle system;
identifying one or more functional anomalies in the functional data streams;
generating or obtaining contextual data relevant to the identified one or more functional anomalies; and
validating or ignoring the identified one or more functional anomalies based at least in part on the contextual data.

17. The method of claim 16, further comprising ordering or prioritizing the one or more validated or ignored functional anomalies.

18. The method of claim 16, wherein the contextual data relates to an functional state of one or more vehicles of the plurality of vehicles.

19. The method of claim 17, further comprising modifying a functional configuration of the vehicle system based at least in part on the one or more validated functional anomalies.

20. The method of claim 17, further comprising transmitting one or more notifications identifying the one or more validated functional anomalies to a display device based on an output of a prioritization routine.
